(19) United States
(12) Patent Application Publication
(10) Pub. No.: US 2010/0095853 A1
(43) Pub. Date: Apr. 22, 2010

(54) Easy-clean food baster

(75) Inventors: Alexander T.F. Lee, New York, NY (US); Dean DiPietro, Brooklyn, NY (US); Mark C. Naden, New York, NY (US); Nicholas A. Oxley, New York, NY (US); Inbal P. Austern, Brooklyn, NY (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 12/288,455

(22) Filed: Oct. 21, 2008

(51) Int. Cl. A47J 37/10

(52) U.S. Cl. 99/345

(57) ABSTRACT

A food baster having an elongated tubular body, a squeezable suction device, and an open-ended tip, is set forth herein. The elongated tubular body is comprised of a plurality of body segments which separate to allow a user to access cavity.

### TECHNICAL FIELD OF THE INVENTION

The present device relates to a food baster. Specifically, the present device relates to a food baster which provides access to the inner cavity for ease of cleaning.

### BACKGROUND OF THE INVENTION

Food basters are common household devices, generally used in cooking but also utilized in a variety of other household tasks requiring a manually-operated suction device. When used as part of the basting cooking method, a baster is integral in maintaining a food's moisture by periodically redistributing juices released by the food, or introducing external moisture such as through the application of sauces, broths, or marinades.

There exist variations on the basic bulb suction food baster design as disclosed in U.S. Pat. No. 2,234,884, including a design which allows for the device to be attached to a canned beverage, disclosed in U.S. Pat. No. 6,575,651. However, existing food basters suffer from a shared deficiency which limits access to the cavity into which fluids are suctioned.

Existing baster designs require users to clean the baster through suctioning water with detergent into the cavity, or submerging the device in a cleaning fluid. This method of cleaning, however, cannot ensure that all particulates are removed from the cavity. The problem exhibited by these baster designs can lead to serious health implications, as failure to properly clean the inside of the device, particularly when involving raw meat juices, can enable harmful bacteria to proliferate and be redistributed upon the next use of the device.

The present invention is intended to address this and other possible problems associated with existing food basters.

### SUMMARY OF THE INVENTION

There is disclosed herein an improved food baster which avoids the disadvantages of prior devices while affording additional structural and operating advantages. The elongated tubular body is comprised of at least two segments for providing access to the inner cavity. At opposing ends of the elongated tubular body is a squeezable suction device and an open-ended tip.

In one embodiment of the food baster, the plurality of segments comprising the elongated tubular body are connected by a living hinge. It is an aspect of one embodiment of the food baster that the living hinge allows for separation of the segments while preserving the unity of the elongated tubular body.

It is another aspect of one embodiment of the food baster that a removable squeezable suction device attaches to one end of the elongated tubular body. It is a further aspect of one embodiment of the food baster that a removable open-ended tip attaches to an end of the elongated tubular body opposing the squeezable suction device.

Finally, it is another aspect of one embodiment of the food baster that the squeezable suction device and the open-ended tip, either in combination or independently, serve to lock the plurality of segments comprising the elongated tubular body.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of one embodiment of the present food baster;

FIG. 2 is a perspective view of the open and disassembled embodiment of the food baster as shown in FIG. 1;

FIG. 3 is another exploded perspective view of the embodiment shown in FIG. 2; and

FIG. 4 is a bottom perspective view of the embodiment of FIG. 2 of the food baster in the open and disassembled condition.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

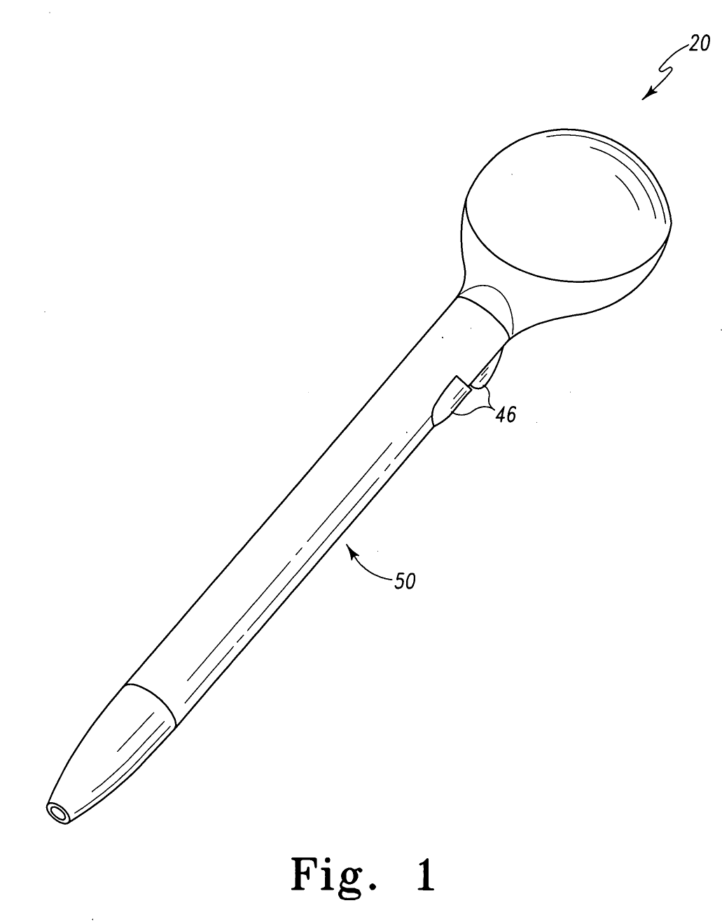

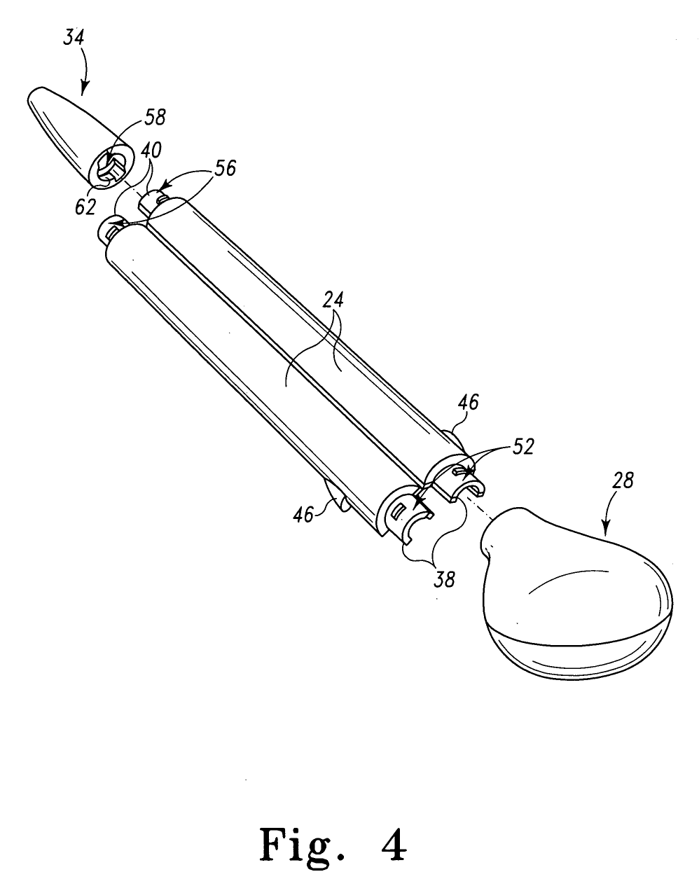

Referring to FIGS. 1-4, there is illustrated a food baster, generally designated by the numeral 20. The food baster 20 is comprised of an elongated tubular body 22, a squeezable suction device 28, and an open-ended tip 34.

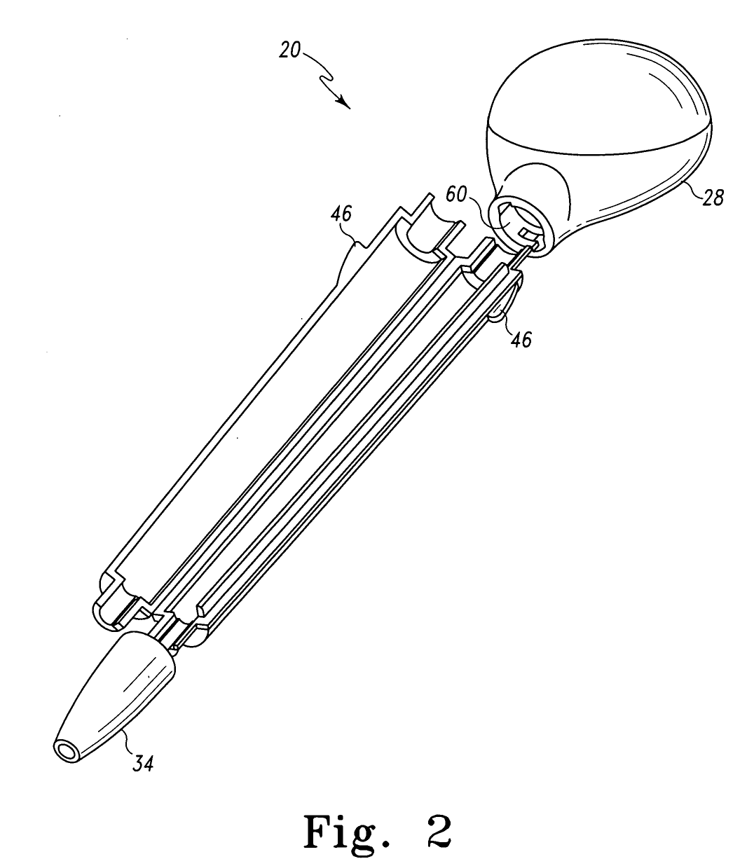

As shown in FIGS. 2-4, the elongated tubular body 22 is comprised of at least two body segments 24 which form a cavity 26. In one embodiment of the present food baster, the body segments 24 are attached along adjacent longitudinal edges 42 by a living hinge 36. The living hinge 36 prevents the body segments 24 from becoming entirely separated from each other, as might occur during the washing process or in storing the food baster after washing. However, the food baster 20 may also be manufactured and operated without a living hinge 36. Additionally, more than one living hinge 36 may be distributed along the adjacent longitudinal edges 42.

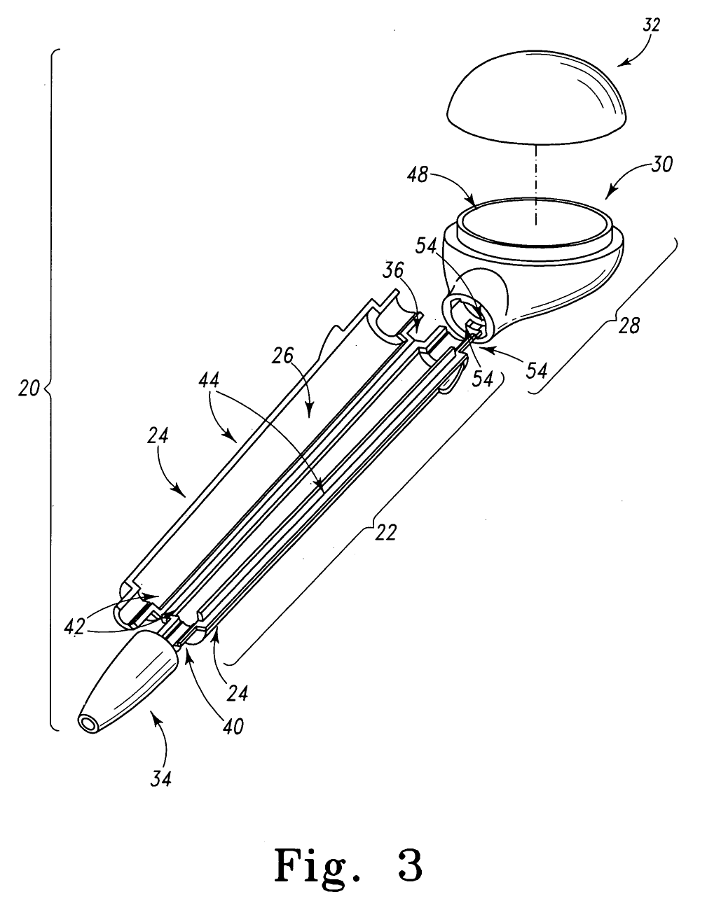

With reference to FIGS. 1-3, the interaction between the body segments 24 can be more readily understood. When the food baster 20 is in the closed position, the body segments 24 are fitted together to form a seal 50 along the meeting longitudinal edges 42. This fitting may be accomplished through a friction fit, as shown in the embodiments depicted in FIGS. 2-3. This fitting may also be accomplished by other means known to those having ordinary skill in the art, including interaction between the body segments 24 by a tongue and groove fit, a detent and recess fit, or by incorporating a sleeve (not shown) which may fit over the body segments 24 to help form a seal 50.

A user may separate the body segments 24 by simultaneously applying diametric pressure to each of two protrusions 46 from the meeting longitudinal edges 44 of the body segments 24. While only two body segments 24 are illustrated in FIGS. 2-4, persons having ordinary skill in the art will understand that numerous body segments 24 may be provided to form the elongated tubular body 22 such that the body segments 24 are fitted together to form a seal 50 in the same manner as with two body segments 24.

FIGS. 2-4 illustrate an embodiment of the food baster 20 where the squeezable suction device 28 and the open-ended tip 34 are removable from the elongated tubular body 22. The squeezable suction device 28 engages a proximal male portion 38 of the elongated tubular body 22. It is an aspect of one embodiment of the food baster 20 that the squeezable suction device 28 is attached to the proximal male portion 38 of the elongated tubular body 22 through interaction of at least one bulb detent 52 and corresponding bulb recess 54. The squeezable suction device 28 may alternatively engage the proximal male portion 38 by providing a threaded inner bulb surface 60 corresponding to a threaded proximal male portion 38. Alternative means of engaging the squeezable suction device 28 with the proximal male portion 38 known to those having ordinary skill in the art could be envisioned, including where the squeezable suction device 28 slides over the proximal male portion 38 to enclose the cavity 26.

One aspect of an embodiment shown in FIG. 3 includes a squeezable suction device 28 comprising a rigid rim 30 and a flexible dome 32. In this aspect, the flexible dome 32 fits upon the lip 48 of the rigid rim 30 to form a seal. In operation, a user applies pressure to the flexible dome 32 to create a suction through the elongated tubular body 22. The squeezable suction device 28 may also be fashioned as a unitary squeezable bulb, as two flexible domes fitted onto a rigid ring, or as any other means for creating a suction through the elongated tubular body 22.

Similarly, the open-ended tip 34 engages a distal male portion 40 of the elongated tubular body 22. In one aspect of an embodiment of the food baster 20, the open-ended tip 34 is attached to the distal male portion 40 of the elongated tubular body 22 through interaction of at least one tip detent 56 and corresponding tip recess 58. The open-ended tip 34 may alternatively engage the distal male portion 40 by providing a threaded inner tip surface 62 corresponding to a threaded distal male portion 40. Alternative means of engaging the open-ended tip 34 with the distal male portion 40 known to those having ordinary skill in the art could be envisioned, including where the open-ended tip 34 slides over the distal male portion 40.

Although the food baster 20 depicted in FIGS. 2-4 illustrates a removable squeezable suction device 28 and removable open-ended tip 34, persons having ordinary skill in the art will understand that these segments need not be removable. Rather, the body segments 24 of the elongated tubular body 22 may be designed to swing over and fit into both or either the squeezable suction device 28 and removable open-ended tip 34, respectively.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

The claimed invention is:

1. A food baster, comprising:
an elongated tubular body comprising two segments defining a cavity therein;
a removable squeezable suction device; and
an open-ended tip.

2. The food baster of claim 1, wherein the two segments of the elongated tubular body are longitudinally separable along at least one edge.

3. The food baster of claim 1, wherein the two segments of the elongated tubular body are connected along an edge by at least one living hinge.

4. The food baster of claim 3, wherein the living hinge extends the length of the two segments of the elongated tubular body.

5. The food baster of claim 3, wherein a plurality of living hinges are dispersed along a length of the two segments of the elongated tubular body.

6. The food baster of claim 1, wherein the removable squeezable suction device is secured to the elongated tubular body by engaging respective male portions extending from the elongated tubular body.

7. The food baster of claim 6, wherein the removable squeezable suction device serves to prevent the two segments of the elongated tubular body from separating when secured to respective extending male portions of the elongated tubular body.

8. The food baster of claim 1, wherein the open-ended tip is removable.

9. The food baster of claim 8, wherein the open-ended tip is secured to the elongated tubular body by engaging respective male portions extending from the elongated tubular body.

10. The food baster of claim 9, wherein the open-ended tip serves to prevent the two segments of the elongated tubular body from separating when secured to respective extending male portions of the elongated tubular body.

11. A food baster, comprising:
an elongated tubular body comprising a plurality of segments defining a cavity therein;
a squeezable suction device; and
an open-ended tip.

12. The food baster of claim 11, wherein the plurality of segments of the elongated tubular body are longitudinally separated.

13. The food baster of claim 11, wherein the plurality of segments of the elongated tubular body are connected by at least one living hinge.

14. The food baster of claim 13, wherein the living hinge extends the length of the plurality of segments of the elongated tubular body.

15. The food baster of claim 13, wherein a plurality of living hinges are dispersed along a length of the two segments of the elongated tubular body.

16. The food baster of claim 11, wherein the squeezable suction device is removable.

17. The food baster of claim 11, wherein the open-ended tip is removable.

18. The food baster of claim 16, wherein the squeezable suction device is secured to the elongated tubular body by engaging respective male portions extending from the elongated tubular body.

19. The food baster of claim 17, wherein the open-ended tip is secured to the elongated tubular body by engaging respective male portions extending from the elongated tubular body.

20. A food baster, comprising:
an elongated tubular body comprising two longitudinally halved segments defining a cavity therein;
a removable squeezable suction bulb; and
an open-ended curved tip;
wherein,
the two segments of the elongated tubular body are hingably connected by a living hinge along adjacent longitudinal edges;
the removable squeezable suction bulb is secured to the elongated tubular body by engaging respective male portions extending from the elongated tubular body;
the removable squeezable suction bulb serves to prevent the two segments of the elongated tubular body from separating when secured to respective extending male portions of the elongated tubular body;
the open-ended curved tip is secured to the elongated tubular body by engaging respective male portions extending from the elongated tubular body; and
the open-ended curved tip serves to prevent the two segments of the elongated tubular body from separating when secured to respective extending male portions of the elongated tubular body.
